(19) United States
(12) Patent Application Publication
(10) Pub. No.: US 2018/0042349 A1
(43) Pub. Date: Feb. 15, 2018

(54) ROLLUP TOOL ORGANIZER

(71) Applicant: Tyler Mitchell Baldwin, Winchester, CA (US)

(72) Inventor: Tyler Mitchell Baldwin, Winchester, CA (US)

(21) Appl. No.: 15/234,137

(22) Filed: Aug. 11, 2016

(51) Int. Cl. A45C 11/26; A45C 13/26; B25H 3/00

(52) U.S. Cl. CPC A45C 11/26; B25H 3/00; A45C 13/26

(57) ABSTRACT

A rollup tool organizer that rolls between a cylindrical configuration and a laid out configuration is provided. The rollup tool organizer provides a head and body member, wherein the body member provides a plurality of pockets along its elongated side edges. The pockets are sequentially arranged and adapted to secure an array of tools therein, which are all visible in the laid out configuration. At one end, the body member is attached along an attachment point to the head member, wherein the attachment point is located proximate but inward of an edge thereof, so when the body member is rolled into a semi-cylindrical configuration it may be disposed near the center of head member, which in turn is rolled about the semi-cylindrical forming a cylindrical configuration that a user may carry to and from job sites.

### BACKGROUND OF THE INVENTION

The present invention relates to an apparatus for organizing and transporting articles and, more particularly, to a rollup tool organizer that rolls between a cylindrical configuration and a laid out configuration, wherein all the tools are organized and visible.

At the end of the day toolboxes, bags and buckets become unorganized because everyone just throws their tools in trying to leave, etc. Other tool organizers are only for small specialty items; they only hold a couple hand tools as their ergonomics are not meant to hold tools of full size or full capacity of a tool box. In other words, they are too small and not adapted to readily carry and organize an entire toolbox, tool bag, or tool bucket. They are also not adapted to have an attached pocket/bag for bulky or loose items.

As can be seen, there is a need for a rollup tool organizer that rolls between a cylindrical configuration and a laid out configuration, wherein all the tools are organized and visible.

### SUMMARY OF THE INVENTION

In one aspect of the present invention, a rollup tool organizer includes an elongated body member of fabric defined by two opposing body side edges extending between a body top edge and a body bottom edge; a plurality of pockets sequentially disposed along each of the two opposing body side edges so that the openings thereof are facing; a head member defined by two opposing head side edges extending between a head top edge and a head bottom edge, wherein a head distance between the two opposing head side edges is greater than a body distance between the two opposing body side edges; and the body top edge joined to the head member along an attachment point, wherein the attachment point is proximate and parallel to and inward from the head bottom edge, and wherein the centerlines of the body and head members are aligned.

In another aspect of the present invention, the rollup tool organizer includes an elongated body member of fabric having a body front surface and an opposing body rear surface, defined by two opposing body side edges extending between a body top edge and a body bottom edge; a plurality of pockets sequentially disposed along the body front surface of each of the two opposing body side edges so that the openings thereof are facing, wherein the plurality of pockets occupy substantially all of the two opposing body side edges; one or two secure straps attached to the body member so as to be parallel to and spaced apart from the openings of the plurality of pockets; a head member having a head front surface and an opposing head rear surface defined by two opposing head side edges extending between a head top edge and a head bottom edge, wherein a head distance between the two opposing head side edges is greater than a body distance between the two opposing body side edges; and the body top edge joined to the head member along an attachment point, wherein the attachment point is proximate and parallel to and inward from the head bottom edge, and wherein the centerlines of the body and head members are aligned; a front pocket attached to the head front surface of the head member, wherein one of the four edges of the front pocket corresponds to the attachment point, wherein another edge of the four edges is an opening having a detachable fastener for closing and opening said opening; and two spaced apart support straps disposed on the rear surfaces of the head and body members, extending from approximately the head top edge to at least half way to the body bottom edge, wherein each of the two spaced apart support straps provides a D ring on one end, and wherein the opposing other end of each support strap is not attached to the body member, whereby the body member is dimensioned and adapted to be rolled up in a semi-cylindrical configuration so as to rest approximately mid-point between the head top and bottom edges.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use in a cylindrical configuration;

FIG. 2 is a top perspective view of an exemplary embodiment of the present invention, shown in use in a laid out;

FIG. 3 is a bottom perspective view of an exemplary embodiment of the present invention;

FIG. 4 is an exploded view of an exemplary embodiment of the present invention;

FIG. 5 is a section view of an exemplary embodiment of the present invention, taken along line 5-5 of FIG. 2;

FIG. 6 is a section view of an exemplary embodiment of the present invention, taken along line 6-6 of FIG. 2;

FIG. 7 is an enlarged section view of an exemplary embodiment of the present invention;

FIG. 8 is a top view of an exemplary embodiment of the present invention;

FIG. 9 is a bottom view of an exemplary embodiment of the present invention;

FIG. 10 is a perspective view of an exemplary embodiment of the present invention; and

FIG. 11 is a top view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rollup tool organizer that rolls between a cylindrical configuration and a laid out configuration. The rollup tool organizer provides a head and body member, wherein the body member provides a plurality of pockets along its elongated side edges. The pockets are sequentially arranged and adapted to secure an array of tools therein, which are all visible in the laid out configuration. At one end, the body member is attached along an attachment point to the head member, wherein the attachment point is located proximate but inward of an edge thereof, so when the body member is rolled into a semi-cylindrical configuration it may be disposed near the center of head member, which in turn is rolled about the semi-cylindrical forming a cylindrical configuration that a user may carry to and from job sites.

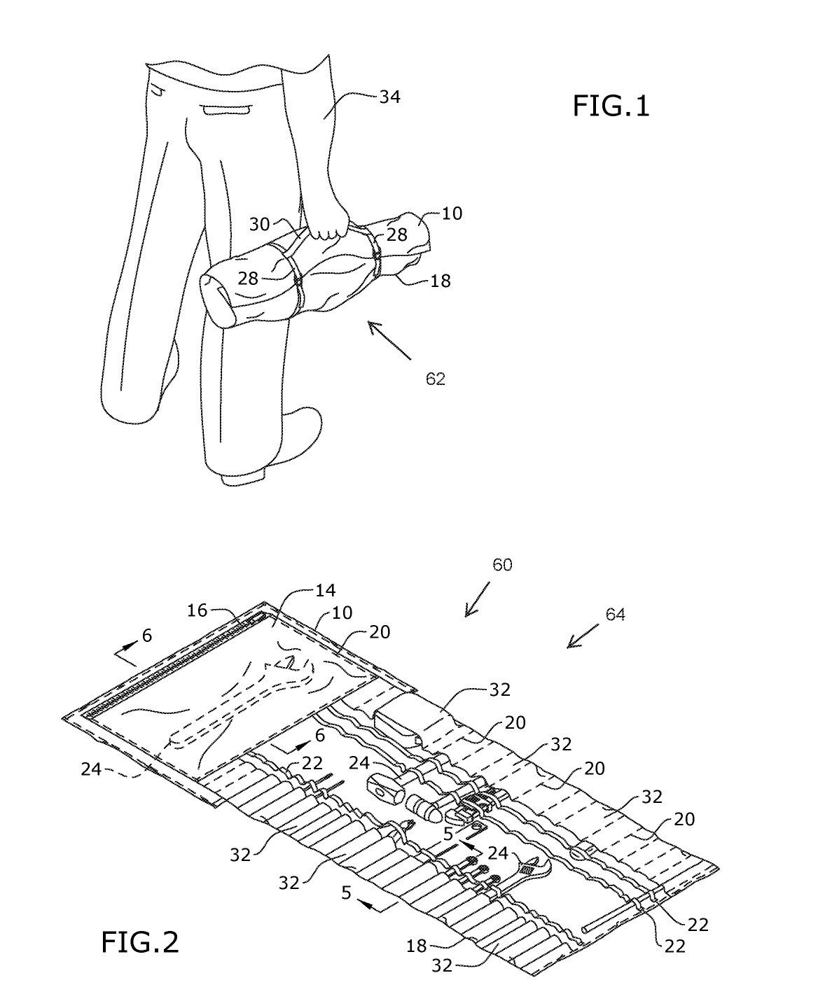

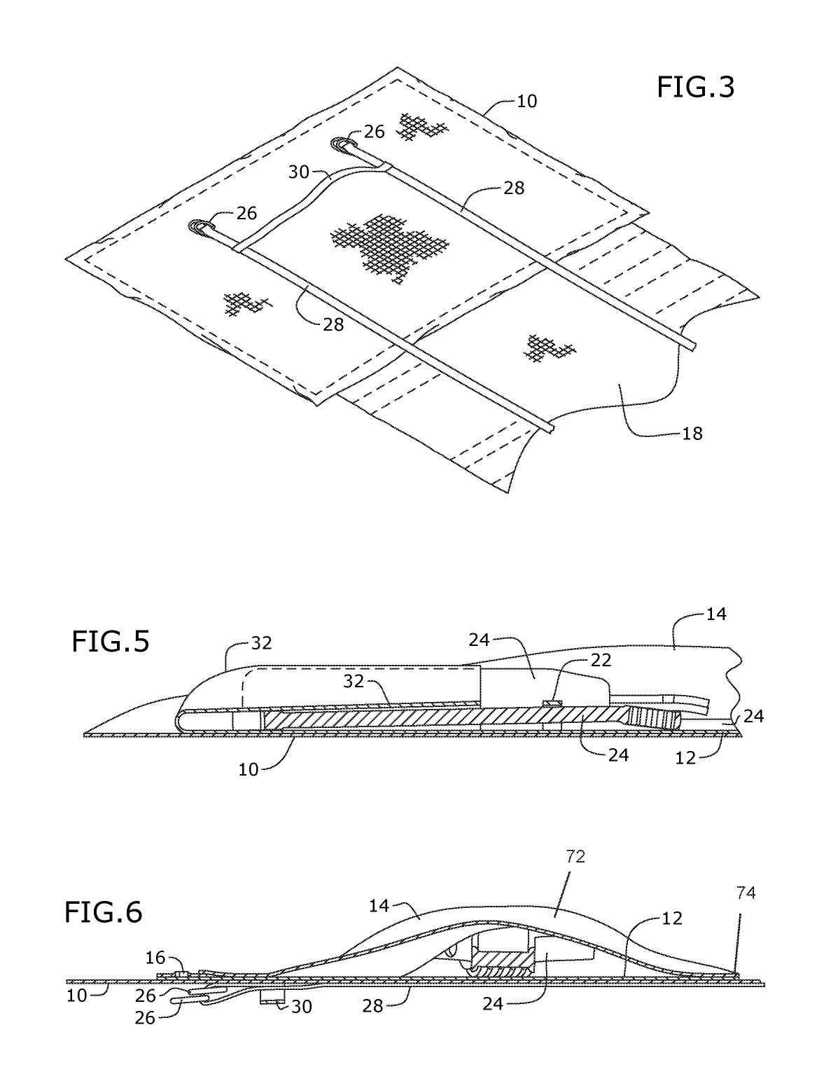

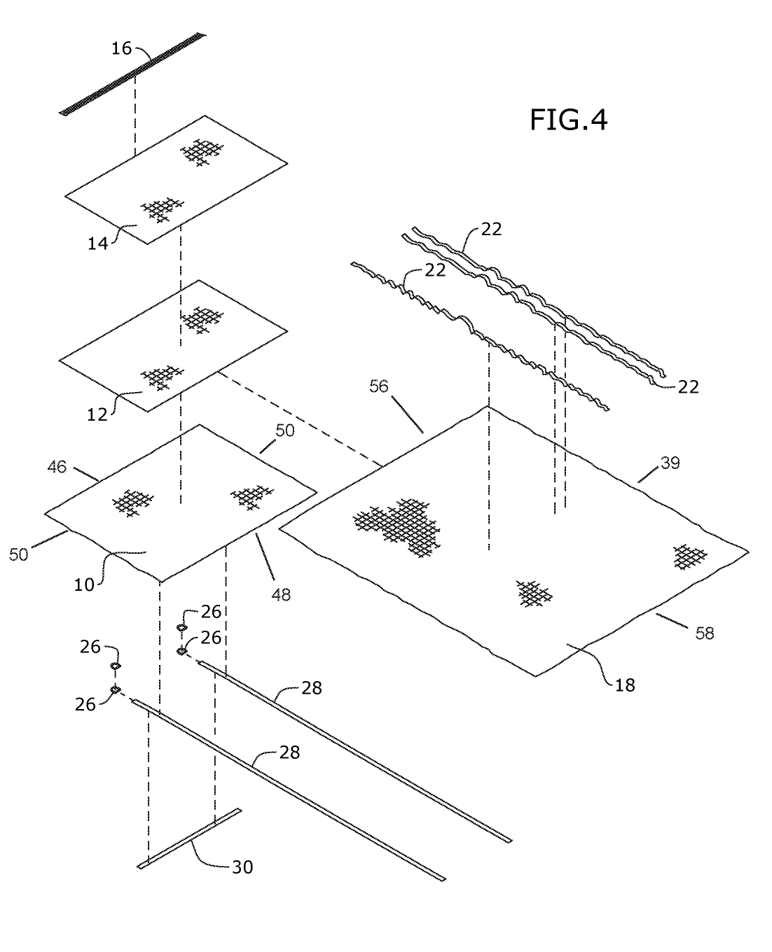

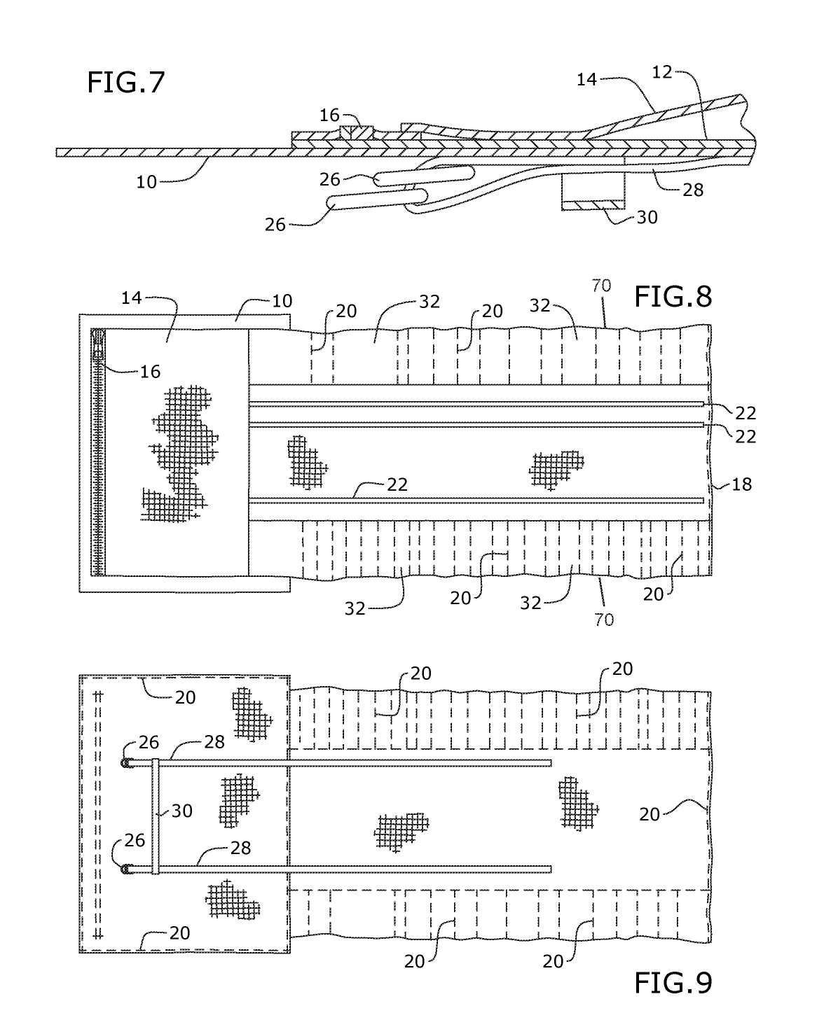

Referring to FIGS. 1 through 9, the present invention may include a rollup tool organizer 60 that rolls between a cylindrical configuration 62 and a laid out configuration 54. The rollup tool organizer 60 may include a body member 18 connected to a head member 10. The body member 18 and the head member 10 may be made of any material that is flexible, durable, and resistant to puncture and tearing, such as heavy duty canvas, leather or the like. Generally speaking, the body member 18 may be an elongated, while the head member 10 may be more square. Though it should be understood that the head and body members may be shaped and dimensioned various ways, so long as the head and body members function in accordance with the present invention as described herein.

The body member 18 may rectangular, defined by a top edge 56, an opposing bottom edge 58 and two side edges 70 extending there between. The head member 10 may similarly have a top edge 46, a bottom edge 48 and two side edges 50. A distance between the two side edges 50 of the head member 10 are greater than a similar distance between the two side edges 70 of the body member 18 so that when the centerline of the two members are aligned, the head member 10 has the greater “wingspan”, the as illustrated in the Figures. The head and body members have a front surface and a rear surface.

Referring to the front surfaces, the head member 10 may provide a first pocket 72 formed by sewing or using other suitable joining techniques to join the three sides of a substantially rectangular front sheet 14 to a generally coextensive backing sheet 12, which in turn is joined along its edges to the head member 10, inward from the head member's edges 46, 48, 50. A fourth edge of the front sheet 14 forms an opening into the respective pocket compartments that may be closed using a zipper 16 or other suitable closure device however.

An attachment point 74 along of one of the four edges of the front and backing sheets 14, 12 that is most proximate but inward from the bottom edge 48 of the head member 10 may correspond to the top edge 56 of the body member 18. Thus, the front and backing sheets 14, 12 and the top edge 56 share the attachment point 74 inward from the bottom edge 48 of the head member 10. The attachment point 74 is achieved by sewing or some other suitable joining technique.

The body member 18 may provide a plurality of pockets 32 formed by folding over the original side edges 39 and stitching 20 at predetermined intervals, which also defines the (new) side edge 70. The plurality of pockets 32 extend from each of the two side edges 70 so that their respective openings face each other, as illustrated in FIG. 2. Spaced away from said openings may be one or two secure straps 22, wherein each secure strap 22 is sewn at the predetermined intervals to form loops that align and correspond with the pockets 32, so that a proximal portion of a tool 24 is housed in a pocket 32 while the tool's distal portion extends therefrom so as to engage said secure strap loops, as illustrated in the Figures. As a result, each of the plurality of pockets 32 extends approximately a quarter of the distance between the two side edges 70. The plurality of pockets 32 may have different widths and by their amount of slack for accommodating differently sized tools 24. Though the pockets 32 are generally elongated having a length to width ratio of approximately at least three to one, they terminate at the same distance from each side edge 70, and they are not spaced apart, but rather are successive—such properties facilitate rolling process.

Referring to the rear surfaces, two spaced apart support straps 28 may be attached so as to extend from near the top edge 46 of the head member 10 toward the bottom edge 58 of the body member 18. At the top edge portion, the support straps 28 may provide D rings 26. At the bottom edge portion, the straps 58 may be unattached to the rear surface. A handle strap 30 may bridge the two support straps 28 near the top edge portion. When the rollup tool organizer is finally rolled up into the cylindrical configuration, the bottom edge portion is slid through the D rings 26 and pulled tight so that a user 34 may grasp the handle strap 30 and take the rollup tool organizer 60 on the go.

A method of using the present invention may include the following. The user 34 may unroll the rollup tool organizer 60 into the laid out configuration, and remove from, secure and otherwise organize their tools 24 in each of the plurality of pockets 32. Through this structure the present invention forces the user 34 to take the time to organize and put their tools in their respective pockets 32. Furthermore, through the offset disposition of the attachment point 74, the body member 18 may be rolled into a semi-cylindrical configuration generally centered over the head member 10, whereby the user 34 may wrap the head member 10 about the semi-cylindrical configuration to form the cylindrical configuration 62, wherein the head member 10 acts as a cover, that is cinched secured by the support straps 58 engaging the D-rings 26.

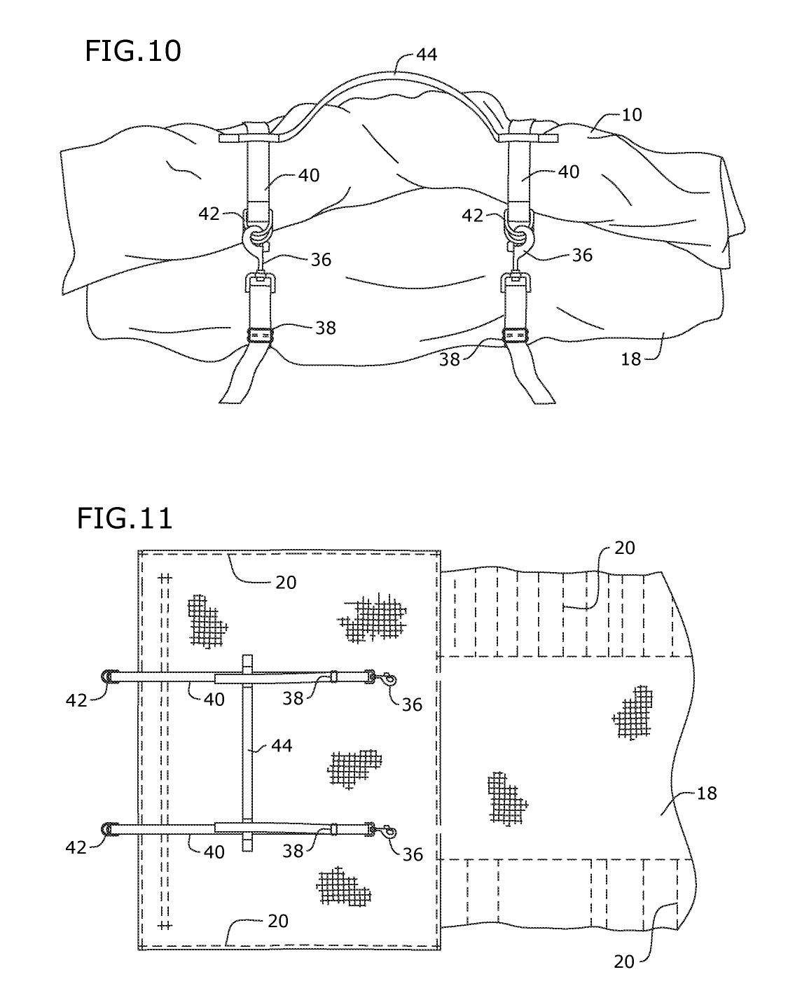

Referring to FIGS. 10 and 11, the present invention may provide along the rear surface of the head member 10, two spaced apart support straps 70 having D rings 72 wherein the straps 70 extend beyond the top edge portion 46, as illustrated in FIG. 11. The support straps 70 may extend from the D rings 72 to clasps connectors 36 between the top edge portion 46 and the bottom edge portion 48, wherein the straps 70 may be unattached to the rear surface. A handle strap 74 may bridge the two support straps 70 between the D rings 72 and the clasp connectors 36. An adjustable slider 38 may operably engage each support strap 70 between the D rings 72 and the clasp connectors 36, so that when the rollup tool organizer 60 rolls to the cylindrical configuration 62 the adjustable sliders 38 can selectively cinch the cylindrical configuration 62, and so enable the clasp connectors 36 to removably secure to the D rings 72, as illustrated in FIG. 10.

It should be understood, of course, that the foregoing relates to exemplary embodiments of the invention and that modifications may be made without departing from the spirit and scope of the invention as set forth in the following claims.

What is claimed is:

1. An apparatus comprising:
an elongated body member of fabric defined by two opposing body side edges extending between a body top edge and a body bottom edge;
a plurality of pockets sequentially disposed along each of the two opposing body side edges so that the openings thereof are facing;
a head member defined by two opposing head side edges extending between a head top edge and a head bottom edge, wherein a head distance between the two opposing head side edges is greater than a body distance between the two opposing body side edges; and
the body top edge joined to the head member along an attachment point, wherein the attachment point is proximate and parallel to and inward from the head bottom edge, and wherein the centerlines of the body and head members are aligned.

2. The apparatus of claim 1, further comprising one or two secure straps attached to the body member so as to be parallel to and spaced apart from the openings of the plurality of pockets.

3. The apparatus of claim 1, wherein the plurality of pockets occupy substantially all of the two opposing body side edges.

4. The apparatus of claim 1, further comprising a front pocket attached to the head member, wherein one of the four edges of the front pocket corresponds to the attachment point.

5. The apparatus of claim 4, wherein another edge of the four edges is an opening having a detachable fastener for closing and opening said opening.

6. The apparatus of claim 1, wherein the head and body members, each have a front surface and an opposing rear surface, and further comprising two spaced apart support straps disposed on the rear surfaces of the head and body members, extending from approximately the head top edge to at least half way to the body bottom edge.

7. The apparatus of claim 6, wherein each of the two spaced apart support straps provides a D ring on one end, and wherein the opposing other end of each support strap is not attached to the body member.

8. The apparatus of claim 1, wherein the body member is rolled up in a semi-cylindrical configuration so as to rest approximately mid-point between the head top and bottom edges.

9. The apparatus of claim 7, further comprising a handle portion extending between the two spaced apart support straps.

10. An apparatus comprising:
an elongated body member of fabric having a body front surface and an opposing body rear surface, defined by two opposing body side edges extending between a body top edge and a body bottom edge;
a plurality of pockets sequentially disposed along the body front surface of each of the two opposing body side edges so that the openings thereof are facing, wherein the plurality of pockets occupy substantially all of the two opposing body side edges;
one or two secure straps attached to the body member so as to be parallel to and spaced apart from the openings of the plurality of pockets;
a head member having a head front surface and an opposing head rear surface defined by two opposing head side edges extending between a head top edge and a head bottom edge, wherein a head distance between the two opposing head side edges is greater than a body distance between the two opposing body side edges; and
the body top edge joined to the head member along an attachment point, wherein the attachment point is proximate and parallel to and inward from the head bottom edge, and wherein the centerlines of the body and head members are aligned;
a front pocket attached to the head front surface of the head member, wherein one of the four edges of the front pocket corresponds to the attachment point, wherein another edge of the four edges is an opening having a detachable fastener for closing and opening said opening; and
two spaced apart support straps disposed on the rear surfaces of the head and body members, extending from approximately the head top edge to at least half way to the body bottom edge, wherein each of the two spaced apart support straps provides a D ring on one end, and wherein the opposing other end of each support strap is not attached to the body member,
whereby the body member is dimensioned and adapted to be rolled up in a semi-cylindrical configuration so as to rest approximately mid-point between the head top and bottom edges.
